(19) United States
(12) Patent Application Publication
(10) Pub. No.: US 2003/0083889 A1
(43) Pub. Date: May 1, 2003

(54) Hotel guest services online

(76) Inventor: Lee Macklin, Colorado Springs, CO (US)

Correspondence Address: HEWLETT-PACKARD COMPANY, Intellectual Property Administration, P.O. Box 272400, Fort Collins, CO, 80527-2400, US

(21) Appl. No.: 09/984,785

(22) Filed: Oct. 31, 2001

(51) Int. Cl. G06F 17/60

(52) U.S. Cl. 705/1

(57) ABSTRACT

A system providing hotel or other accommodation guest services on-line in a guest room. The system includes one or more guest client devices located in the guest room and connected to a server. One or more service client devices also connected with the server are located throughout the hotel in the various service areas of the hotel and elsewhere. The various on-line services provided by the system, such as the ability to order room service, schedule wake-up calls, request house keeping, access on-line gambling, and others, are displayed on the guest client device. When a guest requests one of the on-line guest services, the request is displayed on the appropriate service client device associated with the request.

### TECHNICAL FIELD

The technical field relates to systems and related methods for providing hotel guest services online.

### BACKGROUND

Guests of a hotel oftentimes request a service, such as room service, provided by the hotel. In many instances, a pamphlet is provided in the guests room with a list of phone numbers or extensions to call and request the various services the hotel offers. The guest must then dial the number for the particular service the guest would like and speak to someone in order to request the service. In other instances, the phone in the guest's room will have one or more buttons that are each directly linked with a phone in the appropriate area of the hotel to handle a particular service request. For example, one button might be labeled “room service” and by pressing the button the phone in the kitchen will ring and the guest can order room service.

Servicing guest requests in the manner discussed above requires that a person be present to answer the phone when a guest calls with a request. If the person answering the phone also happens to be the person responsible for servicing the request, then that person oftentimes will have to stop servicing one guest's request to answer the phone when another guest calls with a request. If the phone is not answered when a guest calls, then oftentimes the guest will be unhappy, which may affect the guest's likelihood of returning to the hotel another time.

### SUMMARY

The present invention provides a system for hotels, motels, or other accommodations, with a simple way to request any of the guest services offered by the hotel without impacting the level of responsiveness of the hotel to the guest request, while at the same time helping the hotel staff manage guest requests and respond to guest requests in an efficient and timely manner.

One system according to the invention for a guest of an accommodation to submit a request from a guest room for a guest service from a service area of the accommodation includes a server that processes one or more guest service requests. Guest service requests are provided from a guest room with a guest client device having a display in communication with the server. The guest service request is transmitted to a service client device located in the service area of the hotel having a second display. The service client device is also in communication with the server. Using the system, the guest requests one or more guest services using the guest client device in their room, and the request is received by the server and then displayed on the second display of the service client device for the services staff to view and process the request.

In some embodiments of the invention, the system further includes an e-mail server in communication with the guest client device for providing the guest with a temporary e-mail account accessible from the guest client device, and a web server in communication with the guest client device for providing the guest with Internet access accessible from the guest client device. Some of the requestable services include wake-up calls with an on-line programmable clock, room service with an on-line menu, house keeping with selectable house keeping categories, taxi request, and customized requests displayable on a command service client device at the front desk that also has access to all guest requests and the status of the requests. These services are accessed through links on the guest client device in the guest's room, and then displayed on various service client devices strategically located throughout the hotel in the appropriate service area of the hotel.

One method according to the invention is for a guest of an accommodation to submit a request from a guest room for a service from a service area of the accommodation that includes the operations of providing a server in the hotel or outside the hotel, providing a first client device having a display in the guest room that is connected with or otherwise in communication with the server, providing a second client device having a display in the service area that is also in communication with the server. The method further includes, on the guest client device, displaying a selectable guest service link on the display, and in response to a guest entering a request, receiving a selection of the selectable guest service at the server. The guest service request is then displayed of the display of the service client device.

In some embodiments of the invention, hotel service staff can update the status of progress of servicing guest requests. The method then further includes receiving at the server from the second client device an indication that the selection of the selectable guest service is being acted on, and displaying the indication on the first display. In systems having a command client device, the status of the guest service request is displayed on the command client device.

Additional aspects of the method of the invention include displaying a wake-up call guest service link on the first display for requesting a wake-up call, receiving the wake-up call request at the server, and then displaying a programmable wake-up call clock for setting a wake-up time on the guest client device. The guest may then set a wake-up call time and upon hitting enter, the wake-up call request is received at the server, and then displayed on service client device. In one embodiment, the service client device is likely located in the area of the hotel where the operators generally reside so that they may enter the wake-up call request in the hotel phone system.

Additional aspects of the method according to the invention include displaying a house keeping guest service link on the first display for requesting house keeping, receiving the house keeping request at the server, and displaying the house keeping request on the second display. Additionally, one or more selectable house keeping categories are displayed on the guest client device, and upon selection of one of the house keeping requests by the guest, the category is received at the server and then displayed on the service client device. Numerous house keeping requests categories such as a towel request, a toiletries request, a bedding request, and a room cleaning request may be included.

Another aspect of the method according to the invention includes displaying a selectable room service link for accessing an on-line room service menu on the first display of the guest client deice, receiving the room service request at the server, and then displaying the on-line room service menu with one or more selectable menu items. The guest may then peruse the menu, and select a snack or meal, which selection, is received at the server, and then displayed on the service client device display, which is likely located in the kitchen of the hotel.

Still another aspect of the method of the invention includes displaying a taxi link on the guest client device display for requesting a taxi, receiving the taxi request at the server, and displaying a programmable taxi clock on the first display, wherein the guest provides a taxi service request time. After the guest enters a time that they would like a taxi, the method includes receiving the taxi service request time and displaying the taxi service request time on the service client device display, which is likely located at the concierge desk. The various aspects of the method of the invention may be implemented on a computer-readable medium containing instructions which, when executed, perform the methods. An on-line gambling link may also be provided for access to on-line gambling.

### DESCRIPTION OF THE DRAWINGS

The detailed description will refer to the following drawings, wherein like numerals refer to like elements, and wherein:

FIG. 1 shows a block diagram of a system for providing guest services on-line according to an embodiment of the invention;

FIG. 2 is a block diagram illustrating a plurality of links to on-line guest services provided by the embodiment of FIG. 1;

FIG. 3 is a flowchart illustrating a first method for requesting a wake-up call according to one aspect of the embodiment of FIG. 1;

FIG. 4 is an on-line clock for use in the method illustrated in FIG. 3 and FIG. 8;

FIG. 5 is a flowchart illustrating a method for requesting room service according to one aspect of the embodiment of FIG. 1;

FIG. 6 is an on-line room service menu for use in the method illustrated in FIG.5;

FIG. 7 is a flowchart illustrating a method for requesting house keeping according to one aspect of the embodiment of FIG. 1;

FIG. 8 is a flowchart illustrating a method for checking hotel shuttle schedules according to one aspect of the embodiment of FIG. 1;

FIG. 9 is a flowchart illustrating a method for requesting taxi service according to one aspect of the embodiment of FIG. 1; and

FIG. 10 is a flowchart illustrating a method for submitting a general request to the front desk according to one aspect of the embodiment of FIG. 1.

### DETAILED DESCRIPTION

The invention will now be described in detail with reference to various embodiments thereof, with some aspects of the invention being described in the accompanying drawings. Numerous specific details are set forth in order to provide a thorough understanding of the invention. However, it will be apparent to those skilled in the art that the invention may be practiced without some or all of the specific details, that operations may be rearranged, that some operations may be eliminated or performed in a different way, and that other changes may be made without departing from the spirit and scope of the present invention.

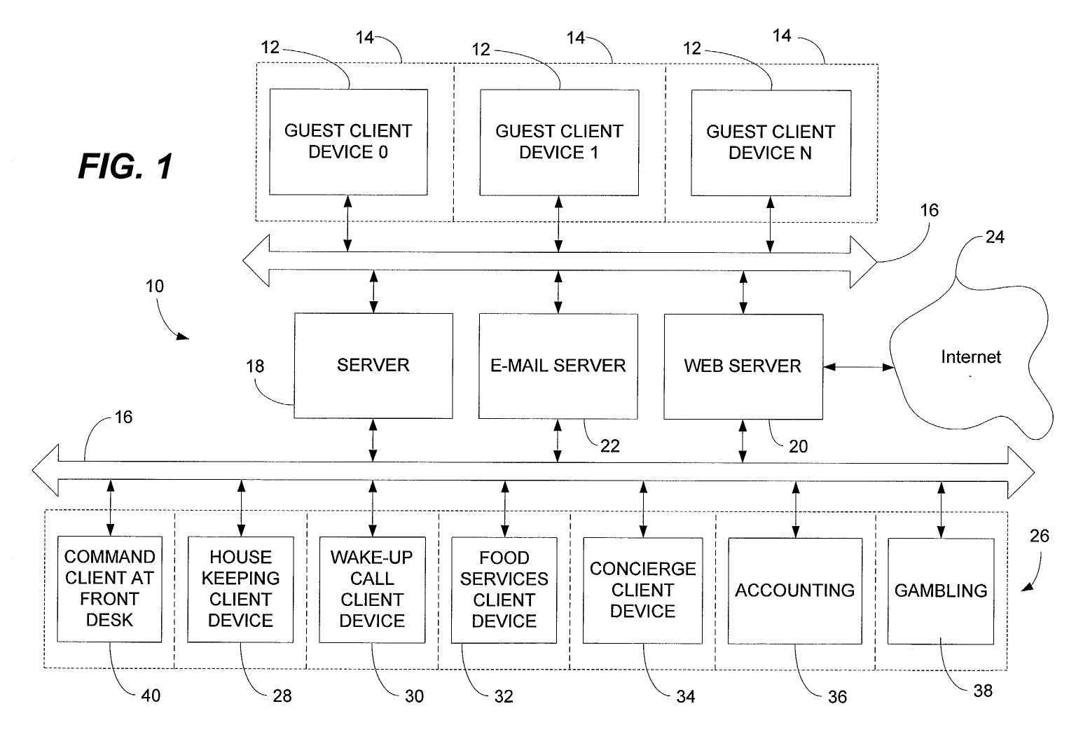

FIG. 1 illustrates a system 10 for providing guest services on-line according to one embodiment of the invention. Generally speaking, the system 10 is implemented in a client-server environment. One or more guest client devices 12 in a guest room 14 of a hotel, motel, or the like, are connected with a network 16, such as a local area network (LAN) or wide area network (WAN). The guest client device 12 may be a personal computer, a terminal, or other device such as a web tablet or personal data assistant that may work as a client in a client-server environment. The guest rooms may also include a network connection port where a guest staying in the room may connect their own laptop computer or other device to the network to serve as the guest client device 12. The guest client devices 12 include an input device such as a keyboard, touchscreen, remote control, mouse, or other input device known in the art, and a display. A guest staying in the room may use the input device to access the various on-line guest services provided by the invention.

A server 18, a web server 20, and an e-mail server 22 are also connected with the network 16. In one example, various aspects of the invention are embodied in executable software running on the server 18. The web server 20 includes a connection to the Internet 24, and is used to access web pages and other Internet content from the guest client device 12 in each guest room 14. The e-mail server 22 provides e-mail services via the guest client device 12 to the guest rooms 14. In one embodiment, a guest receives a temporary e-mail account when she checks in for use while staying at the hotel. As is known in the art, the server 18, the web server 20, and the e-mail server 22 may reside on separate physical devices, such as a personal computer or work station, may reside on a single physical device, or may reside on some combination of devices as a function of the processing power required by the establishment implementing the invention, and other factors.

Various service client devices 26 associated with the on-line guest services accessible and requestable using the invention are also connected with the network 16. In one example, a house keeping service client device 28, a wake-up call service client device 30, a food service client device 32, and a concierge client device 34 are each connected with the network 16. The system 10 may also include an accounting connection 36 and an on-line gambling connection 38. The service client device 26 is present at each guest service location, and when a guest requests one of the guest services provided by the invention, the request is displayed on the appropriate service client device. In one example, the house keeping service client device 28 is located in the housekeeping area of the hotel, the wake-up call service client device 30 is located in the area of the hotel where personnel responsible for scheduling wake-up calls are located, the food service client device 32 is located in the restaurant or other food services areas, and the concierge client device 34 is located at the concierge desk. A service command client device 40 at the front desk may also be included with the system 10, where a global list of all guest service requests and the status of the requests are displayed. The service client devices 26 may also be located throughout the hotel where service staff may have easy access to the service client device 26 while servicing various requests.

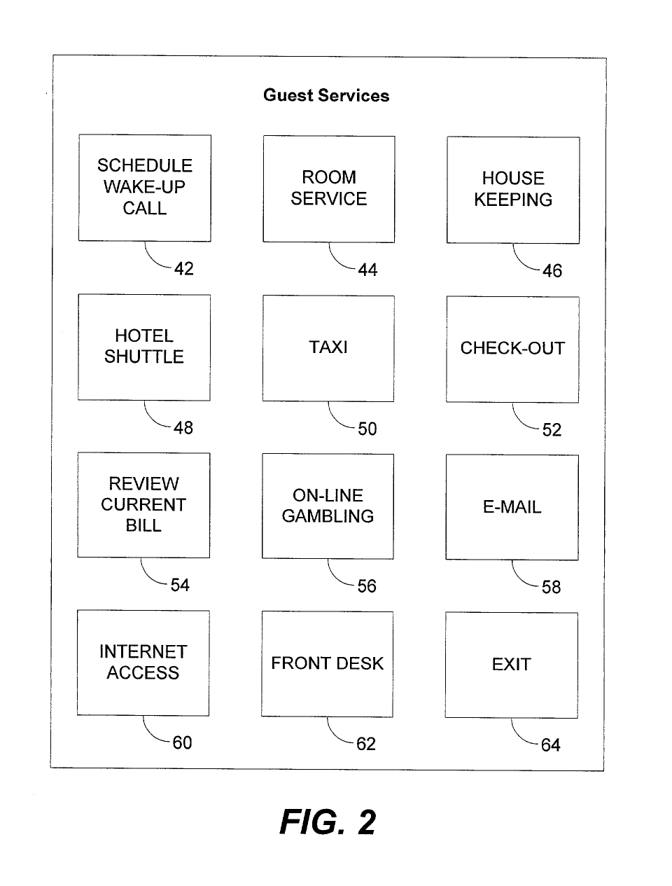

Referring now to FIG. 2, a block diagram is shown illustrating the various on-line guest services accessible from the guest client device 12 in the guest room 14 using the system 10. The on-line guest services include, scheduling a wake-up call using a “schedule wake-up call” link 42, ordering room service using a “room service” link 44, requesting house keeping using a “house keeping” link 46, checking a hotel shuttle schedule using a “hotel shuttle” link 48, requesting a taxi or other transportation using a “taxi” link 50, checking-out using a “check-out” link 52, reviewing the current bill using a “review current bill” link 54, accessing on-line gambling using an “on-line gambling” link 56, accessing a temporary e-mail account using an “email” link 58, accessing the Internet using an “Internet” link 60, and accessing the front desk to enter a request not generally provided by the other guest service links using a “front desk” link 62. The guest exits the system with an “exit” button 64. The guest services associated with each of the above-described links will now be discussed in more detail.

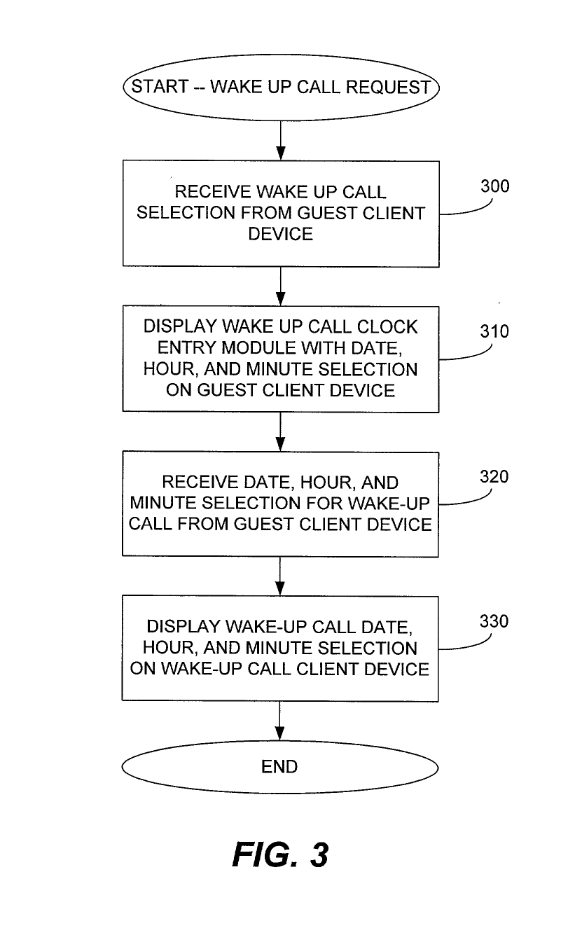

Referring to FIG. 3, a flowchart is shown illustrating a method for requesting a wake-up call according to aspects of the invention. The guest selects the “wake-up call” link 42 displayed on the guest client device 12 in the guest's room, and the server 18 receives the wake-up call selection (operation 300). A wake-up call time entry module is then displayed on the guest terminal (operation 310).

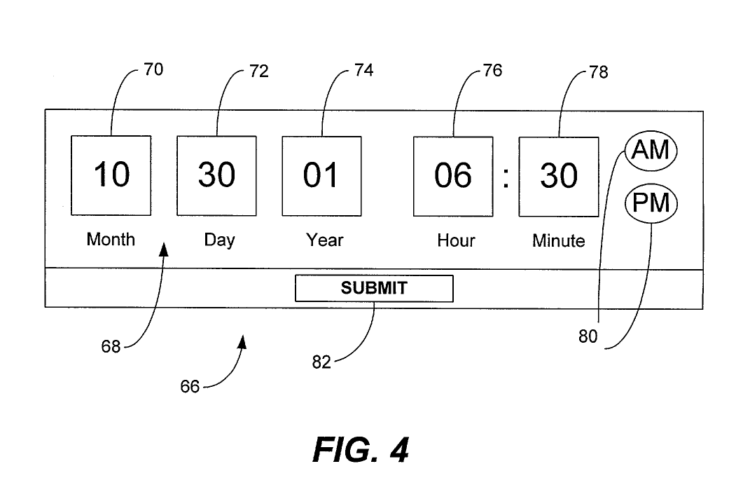

One example of a wake-up call entry clock is illustrated in FIG. 4. The wake-up call entry module includes a clock image 66 having a date selection 68 including a month field 70, a day field 72, and a year field 74. The clock image 66 further includes an hour field 76 and a minute field 78 in FIG. 4. The clock image may also include an AM/PM selection 80. The guest enters the desired time and date for a wake-up call using the wake-up call time entry module illustrated in FIG. 4 and then submits the wake-up call request using a “submit” button 82. The date and time are entered using a keyboard or accessing a drop down window for each field having the appropriate selection. For example, a drop down menu for the month field 70 includes January-December selections.

Referring back to FIG. 3, the server 18 receives the wake-up call request, including the date, hour, minute, and AM/PM selection from the guest (operation 320). The server 18 then transmits the wake-up call request to the hotel operator, and displays the request on the operator's wake-up call service client device 30 (operation 330). The operator in the due course of business may then enter the wake-up call request in the hotel's phone system as is known in the art. One advantage of this aspect of the invention is that the operator is not interrupted by wake-up call requests when engaged in other duties generally performed by a hotel operator as is sometimes the case in hotels that require a guest to call-in a wake-up call request. Rather, using the invention, the hotel operator may enter the wake-up call requests in the phone system when he is not engaged in other activity or during less busy hours of the day, such as in the early morning hours.

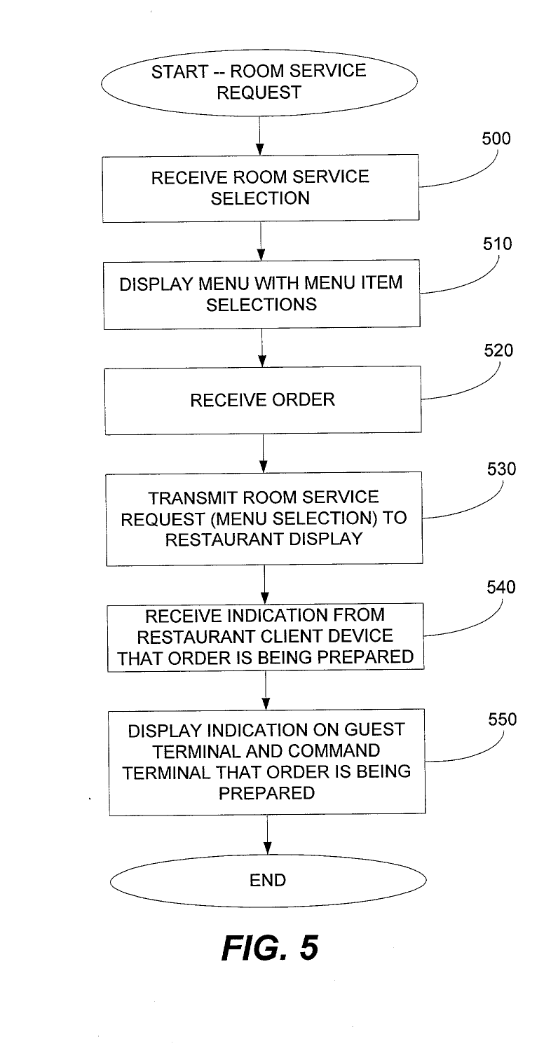

Referring to FIG. 5, a flowchart is shown illustrating a method for requesting room service according to aspects of the invention. The guest selects the “room service” link 44 displayed on the guest client device 12 in the guest's room 14, and the server 18 receives the room service selection (operation 500). A room service entry menu is then displayed on the guest terminal (operation 510). The room service menu may be customized to fit the variety of available room service options that a particular hotel provides. To facilitate providing breakfast to guest rooms in the morning, a separate breakfast menu may be provided with a request clock, similar to the wake-up call request clock illustrated in FIG. 4, for the guest to order breakfast and to request a time at which they would like breakfast to be delivered to their room.

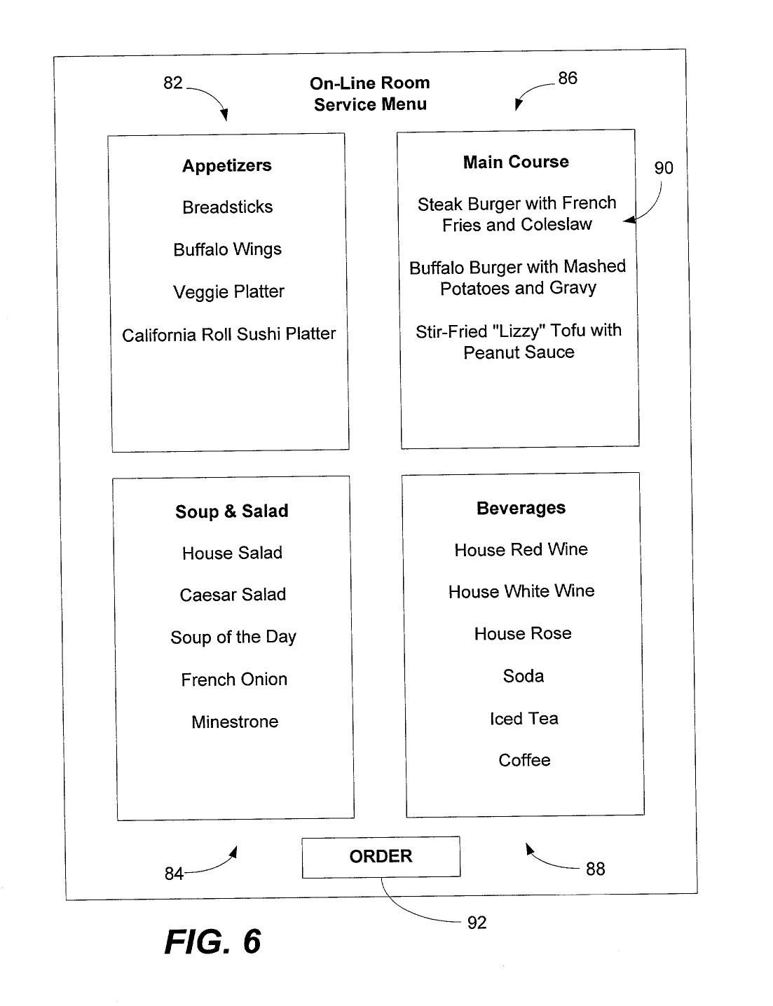

One example of an online room service menu is illustrated in FIG. 6. The room service menu includes an Appetizer section 82, a Soup & Salad section 84, a Main Course section 86, and a Beverage section 88. Under each section are related food selections. For example, under the Main Course section 86, a steak burger with French fries and coleslaw selection 90 is provided. If a guest would like to have the steak burger delivered to their room, then the guest simply selects the steak burger selection 90 after which it will be highlighted. Each selection is indicated, such as by highlighting, so that the guest can see all of their selections. When the guest has completed the room service selections, the guest selects an “order” button 92 on the room service menu.

Referring to FIG. 5, the server 18 receives the order from the guest (operation 520). The server 18 then transmits the room service order to the hotel restaurant or kitchen, and displays the request on the service client device 32 in the restaurant (operation 530). In one example, the room service requests are displayed on the food service client device 32 in the order in which they are received from the various guests staying in the hotel.

The chef or other kitchen worker periodically checks the display for new room service requests. When a new room service request is received, the chef begins preparation of the food and indicates that the food is being prepared by highlighting the room service order on the display, which is in turn received by the server 18 (operation 540). The server 18 then provides an indication on the guest client device 12 that the guest's room service request is being prepared (operation 550). In one example, a message such as “your order is being prepared” is displayed on the guest client device 12.

One advantage of this method is that the chef or other kitchen worker does not have to handle as many room service request calls from the guests and can focus primarily on preparing meals. In addition, room service requests are tracked and displayed in one location rather than being hastily written down as is sometimes the case in busy hotel kitchens especially during peak hours.

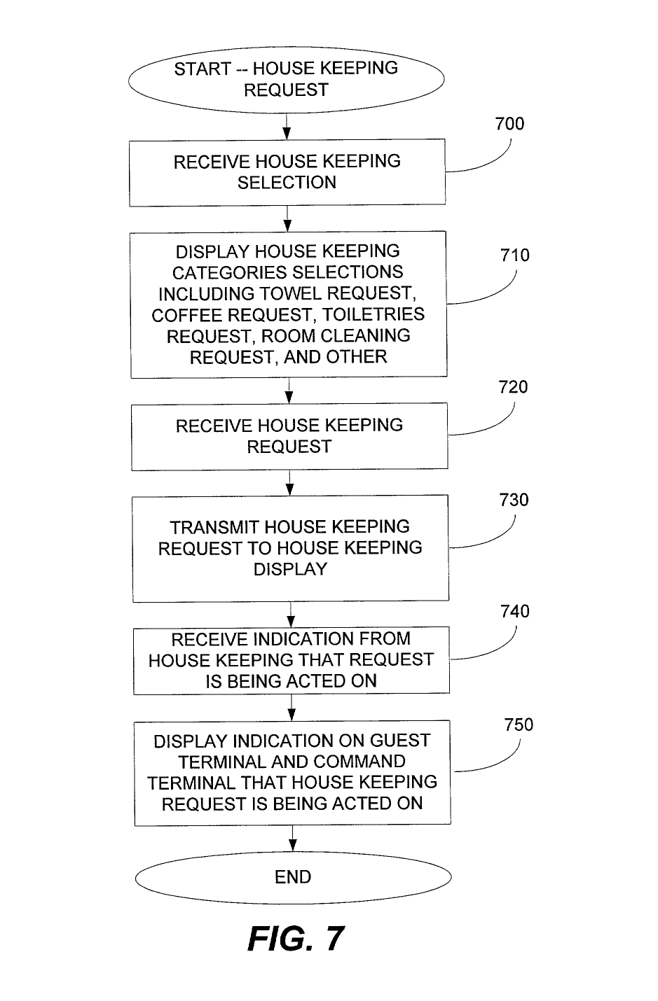

Referring to FIG. 7, a flowchart is shown illustrating a method for requesting housekeeping services according to aspects of the invention. The guest selects the “house keeping” link 46 displayed on the client device 12 in the guest's room 14, and the server 18 receives the house keeping selection (operation 700). In one example, a house keeping message box is displayed for the guest to describe the particulars of the house keeping request. For example, the guest may desire an extra pillow, and might type “I would like an extra pillow” into the message box. In another embodiment, a list of house keeping categories is displayed on the guest client device 12 (operation 710), and the guest selects the appropriate house keeping category. House keeping categories such as soap, shampoo, toothpaste, towels, sheets, extra blanket, extra pillow, clean room, and the like, are envisioned. The house keeping categories may be customized by the particular hotel to align with the type of house keeping services that the hotel provides. In one example, the guest selects each house keeping request, and some indication of the selection, such as highlighting the selection, is provided on the display of the guest client device 12.

The server 18 receives the house keeping request from the guest (operation 720). The server 18 then displays the house keeping request on the service client device 26 display associated with house keeping (operation 730). In one example, the house keeping client device is located wherever the house keeping personnel are generally located in the hotel. The house keeping requests are displayed in the order in which they are received from the various guests staying in the hotel.

It is also possible to provide feedback about the status of the house keeping requests to the guest and front desk. The house keeping person or persons responsible for responding to house keeping requests, in one example, periodically check the house keeping client device 28 display for new house keeping requests. When a house keeping request is received, the house keeping person provides an indication that the house keeping request is going to be acted on, which is in turn received by the server 18 (operation 740). In one example, the house keeper simply clicks on the request, or alternatively selects a button adjacent the request, to indicate that the request is about to be acted on. The server 18 then provides an indication on the guest client device 12 and on the command terminal 40 that the house keeping request is being acted on (operation 750).

It is sometimes the case that house keeping personnel will not be immediately available to receive phone calls for house keeping. One advantage of this method is that guest house keeping requests are entered and displayed on the house keeping client device 28 whether or not house keeping personnel are present to receive a call. When the house keeping person returns to the house keeping area and views the display, action can be taken on the request. In large hotels where there are numerous house keeping requests, a person may be stationed in the house keeping area to monitor the display and to task various house keeping personnel to the various house keeping requests as requests are received.

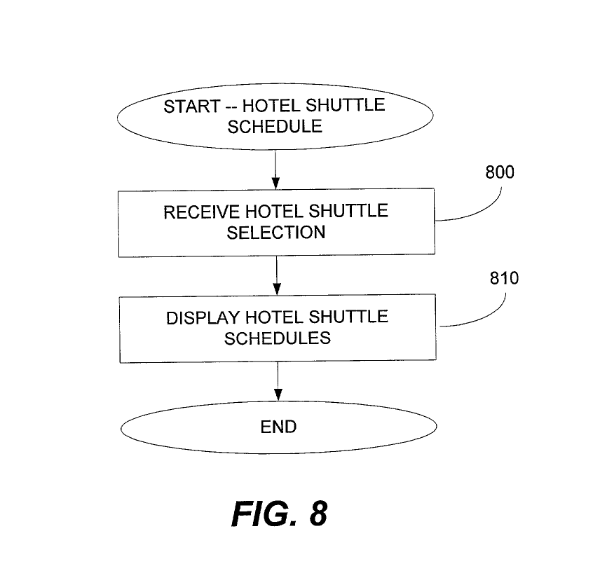

Referring to FIG. 8, a flowchart is shown illustrating a method for checking hotel shuttle schedules according to aspects of the invention. The guest selects the “hotel shuttle” link 48 displayed on the guest client device 12 in her room 14, and the server 18 receives the hotel shuttle selection (operation 800). The server 18 then displays the hotel shuttle schedules (operation 810). Oftentimes, the hotel will provide shuttles to more than one location, such as a shuttle to the airport and a shuttle to a downtown shopping area. Accordingly, the system 10 lists all of the hotel shuttle schedules.

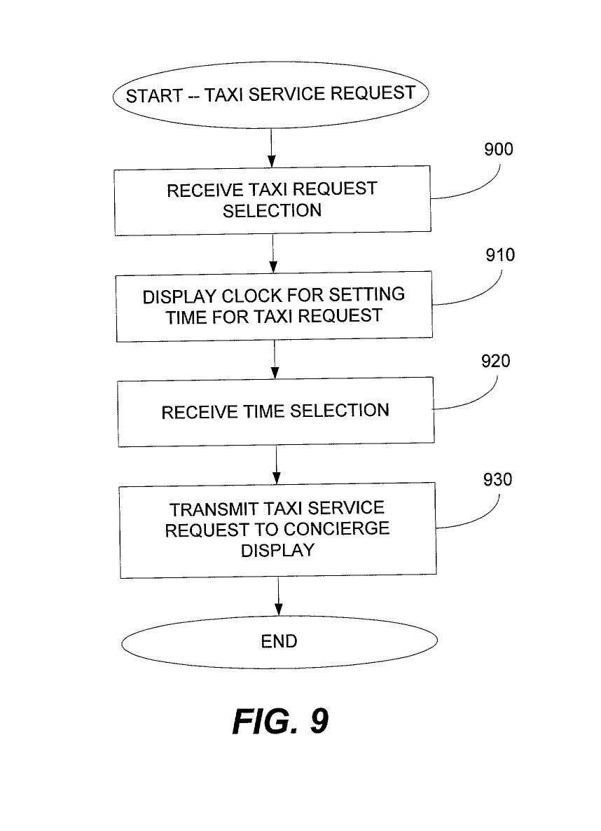

Referring to FIG. 9, a flowchart is shown illustrating a method for ordering taxi service according to aspects of the invention. The guest selects the “taxi” link 50 displayed on the guest client device in her room, and the server 18 receives the taxi request selection (operation 900). The server 18 then provides a clock display (operation 910), such as the clock illustrated in FIG. 4, for the guest to select the date and time for the taxi request. The guest submits the date and time for the taxi, which is sent to the server 18 (operation 920). The server 18 then transmits the day and time, along with the guest information, for the taxi request for display at the concierge client device 34 located at the concierge desk (operation 930).

One advantage of this method is that the guest can order a taxi well in advance of the time the taxi is required. This is beneficial when, for example, the guest arrives at the hotel late at night and needs a taxi early the next morning to go to a meeting. The guest, using the system of the invention, can order the taxi the night when she arrives and not have to arrange for the taxi in the morning when she might be in a rush. The concierge can ensure that the taxi is available the next morning for the guest.

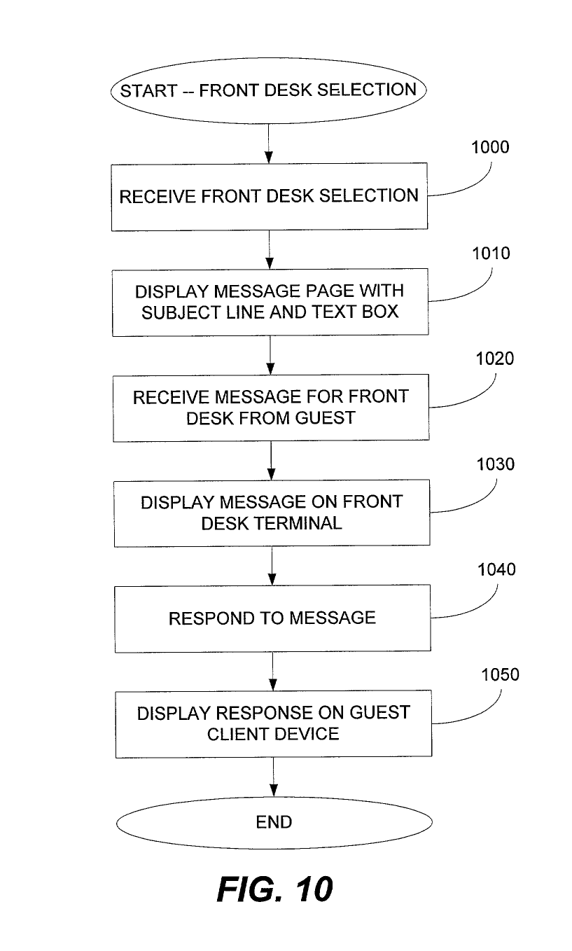

Referring to FIG. 10, a flowchart is shown illustrating a method for providing a customized request to the front desk according to aspects of the invention. Generally, this method is useful for requests that are not covered by the particulars of the preceding methods. For example, a guest might want to know where the nearest all-night-diner is located or want to know if the hotel accepts a particular credit card, which is information she could not discern from other aspects of the invention.

The guest selects the “front desk” link 62 displayed on the client device in her room, and the server 18 receives the front desk selection (operation 1000). A front desk message box is displayed for the guest to describe the particulars of the front desk request (operation 1010). For example, the guest might enter “Do you accept XYZ credit card?” into the message box. A subject line may also be provided along with the message box for the guest to identify the subject of the message. The server 18 receives the front desk message from the guest (operation 1020). The server 18 then transmits the front desk message for display on the command client device 40 located at the front desk (operation 1030). Whomever is at the front desk, may then reply to the message (operation 1040), and the reply is displayed on the guest client device 12 (operation 1050).

One advantage of this method is that the front desk personnel are not interrupted by phone calls when they are assisting guests at the front desk. During especially busy times, one priority of the front desk personnel is to get new guests checked-in. Numerous phone distractions can significantly hamper this effort. This method can help alleviate these distractions especially during peak busy times.

In some hotel locations, such as in Las Vegas, Nev., where the hotel has an associated gambling establishment, an embodiment of the invention includes access to on-line gaming. One example of a system for on-line gaming for access with the invention is described in U.S. Pat. No. 6,206,781 entitled “System and Method for Facilitating Casino Team Play,” which is hereby incorporated by reference in its entirety. Another example of on-line gaming that would work with the present invention is described in U.S. Pat. No. 6,264,560 entitled “Method and System for Playing Games on a Network,” which is hereby incorporated by reference in its entirety. The guests access the on-line gambling system by selecting the “on-line gambling” link 56. Accessing the on-line gambling link 56, connects the guest with the on-line gambling system, and allows the guest to play in her room.

In one embodiment of the invention, the guest may use a temporary e-mail account associated with the guest room. When the guest first arrives at the hotel, the front desk personnel assign the guest a temporary e-mail account name for use while they are staying at the hotel. When in her room, if she would like to use the temporary e-mail account, she selects the “e-mail” link 58, which connects her with an e-mail application, such as LOTUS NOTE™, and the e-mail server 22. The guest may then draft and send an e-mail message in a manner well known in the art. The temporary e-mail account will be associated with the guest until the guest checks-out, at which time the temporary email account is deactivated.

In another embodiment of the invention, the guest has access to the Internet using the system 10. By selecting the “Internet” link 60, the web server 20 launches a web browser, such as Netscape Navigator™, and provides a network connection to the Internet 24. The user may then access web pages and other Internet content, which will be displayed on the browser.

Alternative configurations of the present invention are envisioned. For example, software code embodying aspects of the invention may reside on the server 18, or reside individually on the guest client devices 12 and the service client devices 26 in a distributed manner. The invention can also be embodied as computer readable code on a computer readable medium. The computer readable medium being any storage device that can store data which can thereafter be read by a computer system. Examples of the computer readable medium include a read only memory, a random access memory, a storage area network, a memory stick, magnetic data storage devices such as diskettes, and optical storage devices such as CD-ROMS. The computer readable medium can also be distributed over a network coupled computer system so that the computer readable code is stored and executed in a distributed fashion. The computer readable code may also be distributed using a propagated signal receivable by the computer system and executable therein. The computer readable code may be written in any suitable programming language, and for any suitable computing platform. Some implementations of the present invention may be compiled into a platform-independent format, such as Java™ byte codes, or other formats that can be generated by standard development tools as are well known in the art.

As will be recognized by those skilled in the art from the foregoing description of example embodiments of the invention, numerous variations to these embodiments may be made without departing from the scope of the invention as defined by the following claims. Accordingly, we claim all such changes that come within the scope of the claims.

In the claims:

1. A system for a guest of an accommodation to submit a request from a guest room for a guest service from a service area of the accommodation comprising:
a server, wherein the server processes at least one guest service request;
a guest client device having a display, the guest client device in communication with the server, the guest client device being located in the guest room;
a service client device having a second display, the service client device in communication with the server, the service client device being located in the service area; and
whereby the guest requests the at least one guest service using the guest client device, and the requested at least one guest service is received by the server, and then displayed on the second display of the service client device.

2. The system of claim 1 further comprising an e-mail server in communication with the guest client device, the e-mail server adapted to provide the guest with a temporary e-mail account accessible from the guest client device.

3. The system of claim 1 further comprising a web server in communication with the guest client device, the web server adapted to provide the guest with Internet access accessible from the guest client device.

4. The system of claim 1 wherein the at least one guest service request includes a wake-up call request link, and further comprising an on-line settable wake-up call request clock.

5. The system of claim 1 wherein the at least one guest service request includes a room service request link, and further comprising an on-line room service request menu with a plurality of selectable menu items wherein the guest requests room service by selecting one or more- of the plurality of selectable menu items.

6. The system of claim 1 wherein the at least one guest service request includes a house keeping request link, and further comprising an on-line house keeping menu with a plurality of selectable house keeping categories wherein the guest requests house keeping by selecting one or more of the plurality of selectable house keeping categories.

7. The system of claim 1 wherein the service client device includes: a house keeping client device adapted to be located in a house keeping area of the accommodation and display guest house keeping requests;
a wake-up call client device adapted to be located in a phone operation area of the accommodation and display guest wake-up call requests;
a food services client device adapted to be located in a food preparation area of the accommodation and display guest room service requests; and
a concierge client device located at a concierge desk of the accommodation and display guest taxi requests.

8. The system of claim 7 further comprising:
a command client device adapted to be located at a front desk of the accommodation and to display the at least one guest service request.

9. A method for a guest of an accommodation to submit a request from a guest room for a service from a service area of the accommodation comprising:
providing a server;
providing a first client device in the guest room, the first client device in communication with the server, the first client device having a first display;
providing a second client device in the service area, the second client device in communication with the server, the second client device having a second display;
displaying a selectable guest service link on the first display;
receiving a selection of the selectable guest service at the server; and
displaying the selection of the selectable guest service on the second display.

10. The method of claim 9 further comprising:
receiving at the server from the second client device an indication that the selection of the selectable guest service is being acted on; and
displaying the indication on the first display.

11. The method of claim 10 further comprising:
providing a command client device in communication with the server, the command client device having a third display; and
displaying the indication on the third display.

12. The method of claim 11 further comprising:
displaying a message window on the first display, wherein the user provides a request message;
receiving the request message at the server; and
displaying the request message on the third display.

13. The method of claim 9 further comprising:
displaying a wake-up call guest service link on the first display, the wake-up call guest service link for requesting a wake-up call;
receiving the wake-up call request at the server;
displaying a programmable wake-up call clock for setting a wake-up time;
receiving at the server the wake-up time; and
displaying on the second display the wake-up time.

14. The method of claim 9 further comprising:
displaying a house keeping guest service link on the first display, the house keeping guest service link for requesting house keeping;
receiving the house keeping request at the server; and
displaying the house keeping request on the second display.

15. The method of claim 14 further comprising:
displaying a plurality of selectable house keeping categories;
receiving a selection of one of the plurality of house keeping requests; and
displaying the selection of one of the plurality of house keeping requests on the second display.

16. The method of claim 15 wherein the selectable house keeping categories include a towel request, a toiletries request, a bedding request, and a room cleaning request.

17. The method of claim 9 further comprising:
displaying a selectable room service link on the first display, the selectable room service link for accessing an on-line room service menu;
receiving the room service request at the server;
displaying the on-line room service menu with a plurality of selectable menu items;
receiving a selection of one or more of the plurality of selectable menu items; and
displaying the selection of one or more of the plurality of selectable menu items on the second display.

18. The method of claim 9 further comprising:
displaying a taxi link on the first display, the taxi link for requesting a taxi;
receiving the taxi request at the server;
displaying a programmable taxi clock on the first display, wherein the guest provides a taxi service request time;
receiving the taxi service request time; and
displaying the taxi service request time on the second display.

19. A computer-readable medium containing instructions which, when executed, perform the method of claim 9.

20. The method of claim 9 further including providing an on-line gambling link accessible from the guest client device.
